(19) United States
(12) Patent Application Publication
(10) Pub. No.: US 2006/0200604 A1
(43) Pub. Date: Sep. 7, 2006

(54) METHOD FOR DYNAMICALLY IDENTIFYING ADDRESSES OF DEVICES COUPLED TO AN INTEGRATED CIRCUIT BUS

(76) Inventor: Shih-Ying Lee, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/164,669

(22) Filed: Dec. 1, 2005

(30) Foreign Application Priority Data
Dec. 3, 2004 (TW) 093137367

(51) Int. Cl. G06F 13/00; G06F 3/00

(52) U.S. Cl. 710/104; 710/9

(57) ABSTRACT

The present invention provides a system for dynamically identifying addresses of devices coupled to an integrated circuit bus. The method includes the steps of: starting the devices coupled to the integrated circuit bus; delaying a time period Ta; determining whether the present device receives a signal 0; identifying that the present device is the first device if the present device receives the signal 0; delaying a time period Tb; outputting a signal S1; returning to the determining step, if there is any other device whose address needs to be identified; identifying that the present device is the Nth device if the present device receives a signal S(N−1); and outputting a signal SN.

1. Field of the Invention

The present invention is related to a method for identifying addresses of devices coupled to an integrated circuit bus.

2. Description of Related Art

The Philips Inter Integrated Circuit (I²C) bus is a bi-directional two-wire serial bus, which has been applied broadly because of its low implementing cost and great performance.

Devices on the I²C bus should be assigned to different addresses in order that the devices can be identified and accessed. Normally, the device addresses on the I²C bus are predetermined by hardwiring on circuit boards. Thus, there is a limitation of the I²C bus that it will only allow a single device to respond to each even address between 00 and FF.

Similarly, other devices are like the I²C devices, for example, the devices connected with an integrated circuit. Because each device has a different predetermined address, users need to adjust addresses of the devices when the users install the devices. Furthermore, considering the different address of each device, warehouse administrators need to place the devices separately. So it's inconvenient to store when there are plenty of such devices.

Therefore, what is needed is a method for dynamically identifying addresses of devices coupled to an integrated circuit bus by using a software, which can not only identify the addresses of the devices without any adjustment to the devices, but also can store the devices conveniently.

### SUMMARY OF INVENTION

Embodiments of the present invention provide methods for dynamically identifying addresses of devices coupled to an integrated circuit bus.

One embodiment of such a method, among others, can be broadly summarized by the steps described hereinafter. The method includes the steps of: starting the devices coupled to the integrated circuit bus; delaying a time period Ta; determining whether the present device receives a signal 0; identifying that the present device is the first device if the present device receives the signal 0; delaying a time period Tb; outputting a signal S1; returning to the determining step, if there is any other device whose address needs to be identified; identifying that the present device is the Nth device if the present device is receives a signal S(N−1); and outputting a signal SN.

Other objects, advantages and novel features of the present invention will be drawn from the following detailed description of the preferred embodiment and preferred methods of the present invention with the attached drawings, in which:

### BRIEF DESCRIPTION OF DRAWINGS

FIG. 1 is a schematic diagram illustrating a system for dynamically identifying addresses of devices coupled to an I²C bus, in accordance with one embodiment of the present invention;

FIG. 2 is a schematic diagram illustrating data flow between I²C bus compatible devices which are connected in sequence by an electricity bus;

FIG. 3a and FIG. 3b are exemplary diagrams of two signals respectively; and

FIG. 4 is a flowchart of a preferred method for automatically identifying addresses of devices coupled to the I²C bus.

### DETAILED DESCRIPTION

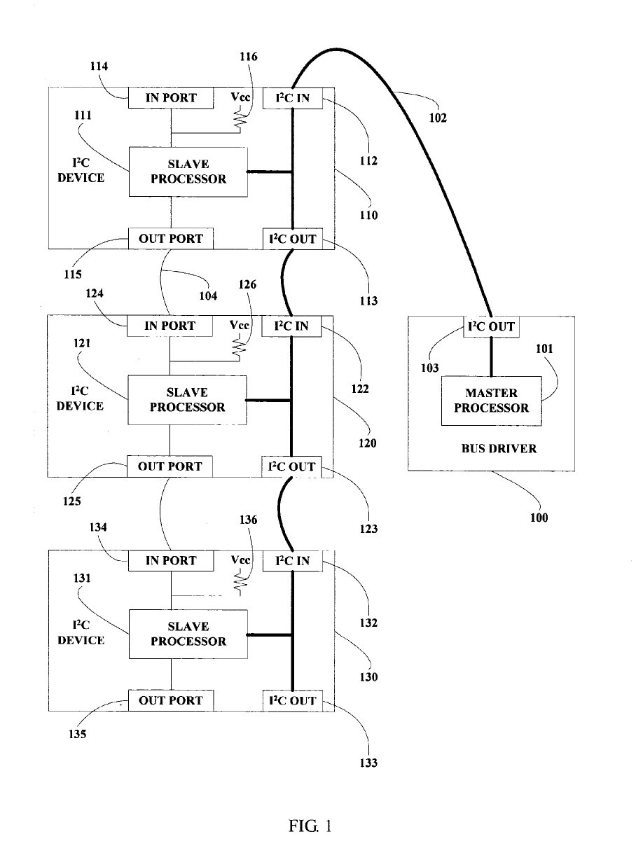

FIG. 1 is a schematic diagram illustrating a system for dynamically identifying addresses of devices coupled to an I²C bus (hereinafter, “the system”), in accordance with one embodiment of the present invention. The system may be a data processing system, such as a computer system, a network computer system, or even a personal digital assistant (PDA). The system employs an I²C bus architecture. The I²C bus 102 is a bi-directional serial integrated circuit bus requiring only two wires: a serial data line (SDL) and a serial clock line (SCL) (combined and represented by the thick line in FIG. 1). Each of a bus driver 100 and three devices (110, 120, 130) connected to the I²C bus 102 can operate either as a transmitter or a receiver. Each I²C bus compatible device has an on-chip interface which allows the device to communicate directly with the other devices via the I²C bus 102. The system has a simple slave/master relationship existing therein. A master is a device which initiates a data transfer and clock signals to permit the transfer. Any device addressed at the time of transfer is considered a slave. In the embodiment, the bus driver 100 acts as a master, while the devices (110, 120, 130) act as slaves. It should be noted that each of the devices (110, 120, 130) coupled to the I²C bus 102 is software addressable by a unique address. In this regard, there is no absolute quantity limitation of devices coupled to the I²C bus 102. In the embodiment, only three devices are coupled to the I²C bus 102.

The bus driver 100 includes a master processor 101, which assigns different addresses to all of the devices (110, 120, 130) in sequence. That is, the master processor 101 assigns an address to the device 110 firstly, then the device 120, and lastly the device 130, because the devices (110, 120, 130) are coupled to the I²C bus 102 serially in the sequence described above. In other words, the device 110 is downstream the I²C bus 102 of the bus driver 100, and the device 120 is downstream the I²C bus 102 of the device 110, and further more, the device 130 is downstream the I²C bus 102 of the device 120.

Additionally, an electrical bus 104 connects the devices (110, 120, 130) in series in the same sequence as the I²C bus 102 connects the devices (110, 120, 130). Each of the devices (110, 120, 130) has similar hardware configuration. Specifically, each of the devices (110, 120, 130) includes a slave processor (111, 121 or 131), an port I²C in (112, 122 or 132) and an port I²C out (113, 123 or 133), an electrical in port (114, 124 or 134) and an out port (115, 125 or 135), and a Vcc (116, 126 or 136) power supply for controlling voltages of the corresponding in port (114, 124 or 134) and the out port (115, 125 or 135).

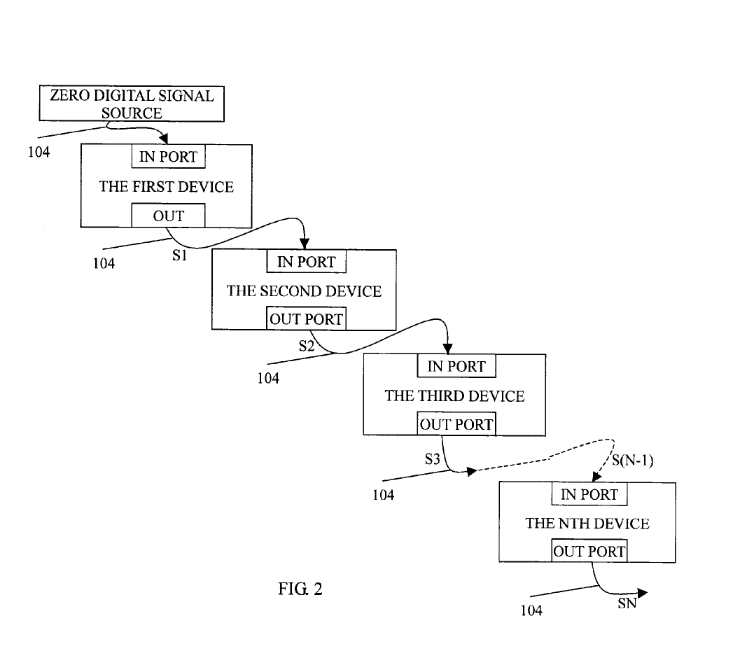

FIG. 2 is schematic diagram illustrating data flow between the I²C bus compatible devices which are connected in sequence by the electricity bus 104. Each I²C bus compatible device (hereinafter “device”) has an in port and an out port (like the device (110, 120 or 130) in FIG. 1). A zero digital signal source connected with the first device outputs signals 0 continuously, which means the in port of the first device receives the signals 0 continuously. Then, the out port of the first device outputs a signal S1, which is sent to the in port of the second device. After receiving the signal S1, the second device outputs a signal S2. Analogously, after the Nth device receives a signal S(N−1), the Nth device outputs a signal SN. N is a whole number which is bigger than 1.

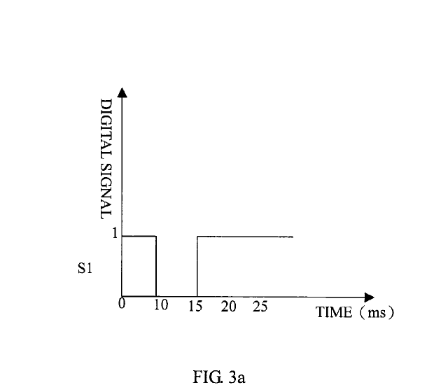

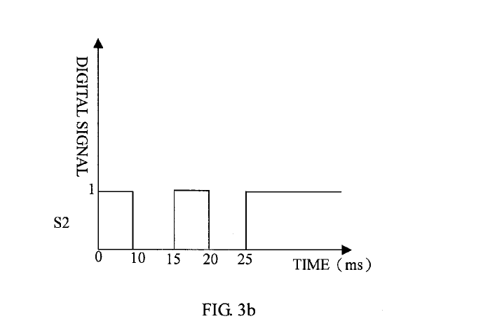

FIG. 3a and FIG. 3b are exemplary diagrams of the signals S1 and S2 respectively. The signals S1 and S2 are members of a signal set S, which can be expressed by (S1, S2, S3 . . . SN). Each signal in the signal set is a transmission mode consisting of a series of digital signals 0 and/or 1. For example, in FIG. 3a, during the time periods 0˜10 ms and 15˜+∞ ms, the signal S1 consists of the digital signals 1; and during the time period 10˜15 ms, the signal S1 consists of the digital signals 0. Similarly, in FIG. 3b, during the time periods 0˜10 ms, 15˜20 ms and 25˜+∞ ms, the signal S2 consists of the digital signals 1; and during the time periods 10˜15 ms and 20˜25 ms, the signal S2 consists of the digital signals 0. The signals are transmitted in the electricity bus 104.

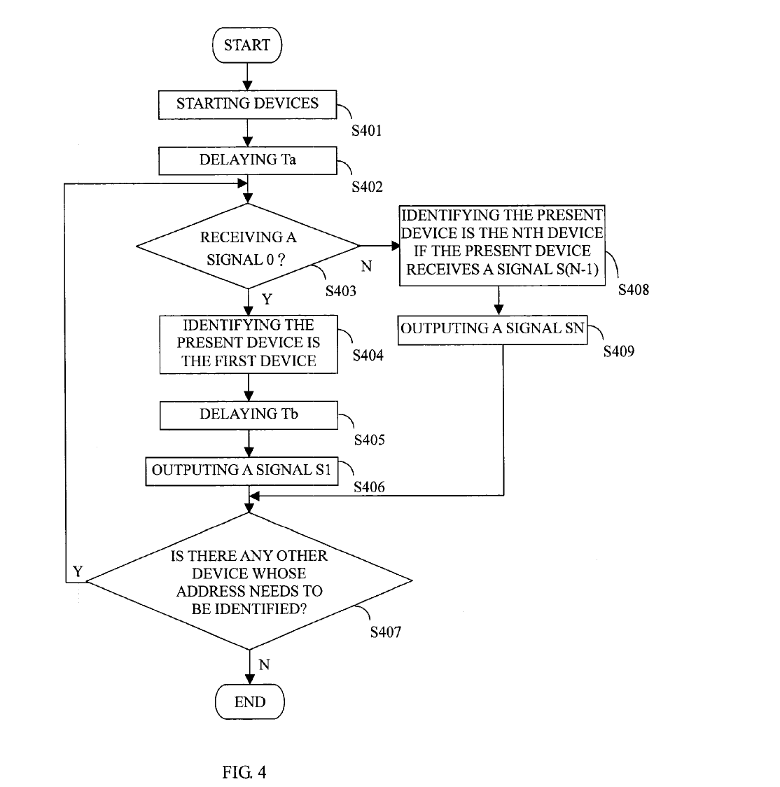

FIG. 4 is a flowchart of a preferred method for automatically identifying addresses of devices coupled to the I²C bus 102 in accordance with one embodiment of the present invention. In this preferred embodiment, a plurality of devices (e.g. N, N>1) are coupled to the I²C bus 102. In step S401, the master processor 101 of the bus driver 100 starts all the devices coupled to the I²C bus 102. In step S402, the master processor 101 delays a time period Ta, in order to make sure that a zero digital signal source outputs a digital signal 0 to a device connected thereto, and to ensure each device starts and outputs a digital signal 1. Ta is a certain period determined by a user, which may be, for example, 5 seconds, 6 seconds and so on. In step S403, the master processor 101 determines if the present device receives a signal 0. If the present device doesn't receive a signal 0, the procedure goes directly to step S408 described below. Otherwise, if the present device receives a signal 0, in step S404, the master processor 101 identifies that the present device is the first device. In step S405, the master processor 101 delays a time period Tb, in order to make sure that the second device is read to receive a signal S1 output from the first device. Tb is a time period longer than Ta. In step S406, the first device outputs the signal S1. In step S407, the master processor 101 determines whether there is any other device whose address needs to be identified. If there is any other device whose address needs to be identified, the procedure returns to step S403 described above. In contrast, if addresses of all the devices have been identified, the procedure ends.

In step S408, if the present device doesn't receive a signal 0, but receives a signal S(N−1), then the master processor 101 identifies the present device is the Nth device. In step S409, the Nth device outputs a signal SN after receiving the signal S(N−1), whereupon the procedure returns to step S407 described above.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A method for dynamically identifying addresses of devices coupled to an integrated circuit bus, the method comprising the steps of:
starting the devices coupled to the integrated circuit bus;
delaying a time period Ta;
determining whether the present device receives a signal 0;
identifying that the present device is the first device if the present device receives the signal 0;
delaying a time period Tb;
outputting a signal S1;
returning to the determining step, if there is any other device whose address needs to be identified;
identifying that the present device is the Nth device if the present device receives a signal S(N−1); and
outputting a signal SN.

2. The method according to claim 1, wherein the integrated circuit bus is an inter integrated circuit bus.

3. The method according to claim 1, wherein Tb is a time period longer than Ta.

4. The method according to claim 1, wherein the signals S1, S(N−1) and SN are members of a signal set S, which can be expressed by (S1, S2, S3 . . . SN).

5. The method according to claim 4, wherein each signal in the signal set S is a transmission mode consisting of a series of digital signals 0 and/or 1.
